(19) United States
(12) Patent Application Publication
(10) Pub. No.: US 2016/0254980 A1
(43) Pub. Date: Sep. 1, 2016

(54) RELAY DEVICE AND COMMUNICATION NETWORK

(71) Applicant: MITSUBISHI ELECTRIC CORPORATION, Chiyoda-ku, Tokyo (JP)

(72) Inventor: Toshiyuki NAKAYASU, Tokyo (JP)

(73) Assignee: Mitsubishi Electric Corporation, Tokyo (JP)

(21) Appl. No.: 15/033,139

(22) PCT Filed: Jun. 4, 2014
(86) PCT No.: PCT/JP2014/064855

§ 371 Date: Apr. 29, 2016

(30) Foreign Application Priority Data
Nov. 25, 2013 (JP) 2013-242753

(51) Int. Cl. H04L 12/26; H04B 7/14

(52) U.S. Cl. CPC H04L 43/16; H04B 7/14

(57) ABSTRACT

A relay device belonging to a communication network includes: a plurality of communication ports to transmit and receive frames; and a reception frequency monitoring unit. The reception frequency monitoring unit monitors a frequency of reception of a control frame with respect to each of the communication ports, the control frame being periodically transmitted into the communication network from a communication device belonging to the communication network. The reception frequency monitoring unit instructs a communication port at which the frequency of reception exceeds a threshold to stop a frame transmission and reception operation.

### FIELD

The present invention relates to a relay device that relays a frame communicated between communication devices belonging to a communication network.

### BACKGROUND

In recent years, use of the Ethernet (registered trademark) is increasing in an industrial field, and a communication network (hereinafter referred to as an FA network) connecting between FA (Factory Automation) devices such as PLCs (Programmable Logic Controllers), inverters, sensors, and the like is constructed at a manufacturing floor. It is typical in the FA network that the Ethernet is used to connect between the FA devices of which real-time property is required and to control them. A CC-Link IE (registered trademark) is known as such the Ethernet-based FA network.

In the CC-Link IE, a communication device on a controlling side (hereinafter referred to as a master) and a communication device to be controlled (hereinafter referred to as a slave) are connected to each other through the Ethernet, and communication is performed based on a token passing method using multicast communication (Patent Literature 1, for example).

According to a communication system described in Patent Literature 1, a master periodically broadcasts a network presence confirmation frame (hereinafter referred to as TestData) to slaves to be controlled. Based on slave connection information included in TestDataAck being a response from the slave, the master performs detection of a newly-connected terminal and setting of a token circulation path.

After determining the token circulation path, the master notifies the slaves of respective transmission destinations of a token. After notifying the slaves of the token circulation path, the master multicast-transmits own data and the token. A MAC (Media Access Control) address of a slave to which a transmission right is given next is stored in the multicast-transmitted token. A slave receiving the token including its address recognizes that the slave acquires the transmission right. Then, the slave multicast-transmits the token to the next slave, after transmitting data as appropriate. In the CC-Link IE, control is performed such that a period after the master transmits the token until the master receives the token including its address is less than a preset period. This series of processes is performed repeatedly, and thereby the master and the slave perform a communication periodically (hereinafter referred to as a cyclic communication).

In the case of the FA network that is configured by connecting various FA devices to a relay device such as a layer 2 switch, there is a possibility that a communication path is erroneously constructed by a human error or the like and thus a loop path is formed. In the FA network, the formation of the loop path causes a storm, which then interferes with a network operation. Here, the storm is a phenomenon that forwarding and duplicating of broadcast frames and multicast frames are repeated endlessly on the loop path, resulting in strain on network bandwidth. In the case of the FA network, high reliability is required and thus a mechanism that autonomously detects and resolves the loop path is important.

The following is known as a conventional method of detecting a loop path in the Ethernet. That is, one periodically transmits a specially-defined test frame for loop detection, receives the test frame transmitted by it, and detects a loop path (Patent Literature 2, for example).

### CITATION LIST

### Patent Literature

Patent Literature 1: Japanese Patent No. 5084915

Patent Literature 2: Japanese Patent Application Laid-Open No. 2012-44384

### SUMMARY

### Technical Problem

However, in the case of the CC-Link IE, there is no means of detecting the loop path by a communication terminal and resolving the loop path without help of a network administrator, which is a problem.

In a case where the technique described in Patent Literature 2, where one detects a loop by receiving the test frame transmitted by it, is applied to the CC-Link IE, it is necessary to adjust transmission timings of the test frames so as not to cause conflict between the test frames and CC-Link IE control frames sensitive to delay. Also, when the specially-defined test frame is used, a communication terminal may drop the test frame when forwarding it, from a viewpoint of security.

The present invention has been achieved in view of the foregoing, and an object of the present invention is to achieve a relay device and a communication network that easily detect a loop path with a simple configuration and autonomously resolve the loop path in the CC-Link IE.

### Solution to Problem

To solve the above-mentioned problem and achieve the object, the present invention provides a relay device belonging to a communication network. The relay device includes: a plurality of communication ports to transmit and receive frames; and a reception frequency monitoring unit to monitor a frequency of reception of a control frame with respect to each of the communication ports, the control frame being periodically transmitted into the communication network from a communication device belonging to the communication network, and to instruct a communication port at which the frequency of reception exceeds a threshold to stop a frame transmission and reception operation.

### Advantageous Effects of Invention

The relay device according to the present invention brings about effects that a loop path can be detected easily and the loop path can be resolved autonomously.

### BRIEF DESCRIPTION OF DRAWINGS

FIG. 1 is a diagram illustrating an example of a communication network according to the present invention.

FIG. 2 is a diagram illustrating an example of a configuration of a layer 2 switch.

FIG. 3 is a diagram illustrating an example of an operation of a layer 2 switch according to a first embodiment.

FIG. 4 is a diagram illustrating an example of an operation of a layer 2 switch according to a second embodiment.

FIG. 5 is a diagram illustrating an example of an operation of the layer 2 switch according to the second embodiment.

FIG. 6 is a diagram illustrating an example of a communication network according to a third embodiment.

### DESCRIPTION OF EMBODIMENTS

Exemplary embodiments of a relay device and a communication network according to the present invention will be described below in detail with reference to the drawings.

It should be noted that the present invention is not limited to the embodiments.

### First Embodiment

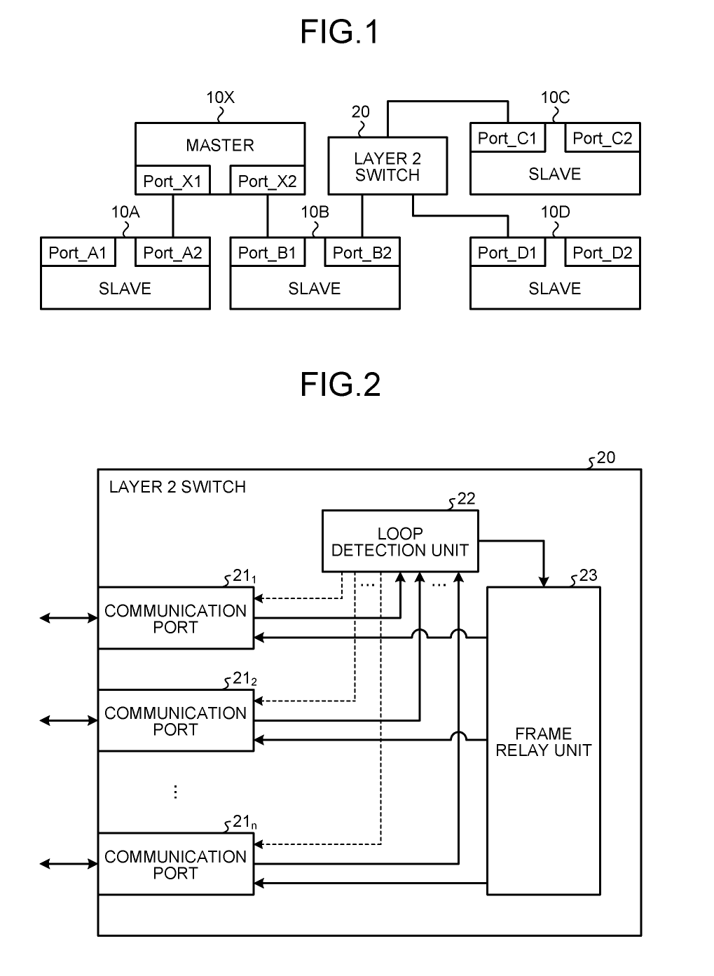

FIG. 1 is a diagram illustrating an example of a CC-Link IE network as a communication network according to the present invention. The CC-Link IE network is configured by a network of the same segment in which plural communication terminals are connected in a line-shape or in a star-shape through the Ethernet.

The communication network illustrated in FIG. 1 includes a communication terminal 10 operating as a master, a plurality of communication terminals 10A to 10D operating as slaves, and a layer 2 switch 20 being a relay device. Each of the communication terminals 10 (communication terminals 10X and 10A to 10D) is provided with two communication ports. The communication port of a communication terminal 10 is connected to the communication port of another communication terminal 10 or a communication port of the layer 2 switch through a LAN (Local Area Network) cable. The communication terminal 10 is connected to an FA (Factory Automation) device or is embedded in the FA device, and transmits/receives control information and data of the FA device to/from another communication terminal 10.

In the communication network exemplified in FIG. 1, a first communication port (Port_X1) of the communication terminal 10X and a second communication port (Port_A2) of the communication terminal 10A are connected to each other, and a second communication port (Port_X2) of the communication terminal 10X and a first communication port (Port_B1) of the communication terminal 10B are connected to each other. A second communication port (Port_B2) of the communication terminal 10B is connected to the layer 2 switch 20. A first communication port (Port_C1) of the communication terminal 10C is connected to the layer 2 switch 20, and a first communication port (Port_D1) of the communication terminal 10D is connected to the layer 2 switch 20.

In the communication network according to the present embodiment, the relay device such as the layer 2 switch 20 is provided with a mechanism that monitors a flow rate of a network presence confirmation frame (TestData) periodically transmitted from the communication terminal 10X being the master of the CC-Link IE and determines occurrence of a loop path when the number of times of reception of TestData per unit time exceeds a threshold. Here, the network presence confirmation frame is a frame that is periodically transmitted from the communication terminal 10X being the master in order to detect a new terminal that is not yet registered in a token circulation path.

FIG. 2 is a diagram illustrating an example of a configuration of the layer 2 switch 20. As shown in FIG. 2, the layer 2 switch 20 includes a plurality of communication ports 21 (communication port 21₁ to 21ₙ), a loop detection unit 22 operating as a reception frequency monitoring unit, and a frame relay unit 23.

The loop detection unit 22 once receives a frame received at each communication port 21, determines whether the received frame is the network presence confirmation frame (TestData frame) or not, and calculates a frequency of reception of said frame (the number of times of reception of TestData frame per unit time) with respect to each communication port 21. If the frequency of reception of the TestData frame exceeds a preset threshold, the loop detection unit 22 determines that a loop path is formed. The frame received from each communication port 21 is output to the frame relay unit 23.

The frame relay unit 23 manages a table (MAC address table) indicating a correspondence relationship between MAC addresses and the communication ports 21. When receiving, through the loop detection unit 22, a frame received by each communication port 21, the frame relay unit 23 outputs the received frame to a communication port 21 associated with a MAC address being destination of the received frame. When receiving a broadcasted frame such as the TestData frame, the frame relay unit 23 outputs the received frame to all the communication ports 21 other than the communication port 21 at which the frame is received.

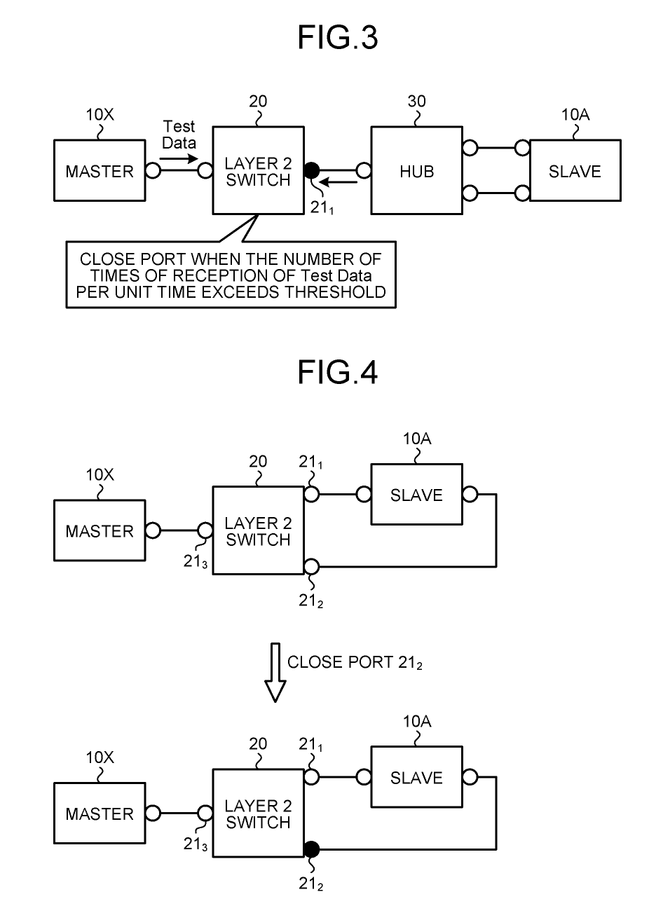

Next, a whole operation of the layer 2 switch 20 will be described. As an example, an operation in the communication network having a configuration shown in FIG. 3 will be described. FIG. 3 is a diagram illustrating an example of a case where a loop path is formed down the layer 2 switch 20. The communication network shown in FIG. 3 has a configuration in which the communication terminal 10X being the master and the communication terminal 10A being the slave are connected to each other through the layer 2 switch 20 and a hub 30. The hub 30 is connected to the communication port 21₁ of the layer 2 switch 20, and a loop path is generated between the hub 30 and the communication terminal 10A. Note that when receiving a frame, the hub 30 forwards the received frame to all communication ports other than the communication port that receives the frame.

In the case of the communication network having the configuration shown in FIG. 3, forwarding and duplicating of the TestData frame transmitted by the communication terminal 10X are repeatedly performed on the loop path. As a result, the number of times of reception of the TestData frame per unit time at the communication port 21₁ of the layer 2 switch 20 exceeds the preset threshold, and thus the loop detection unit 22 detects presence of the loop path. When detecting the loop path, the loop detection unit 22 closes the detected communication port 21₁. That is, the loop detection unit 22 instructs the communication port 21₁ where the loop path is detected not to perform frame transmission and reception, and the communication port 21₁ receiving the instruction stops stops the frame transmission and reception operation. Accordingly, the loop path is isolated from the CC-Link IE network.

In the above example, the loop detection unit 22 and the frame relay unit 23 are separated in the layer 2 switch 20. Besides, a configuration in which the frame relay unit 23 has the function of the loop detection unit 22 (the frame relay unit 23 performs the loop detection) also is possible.

In the above example, the loop detection unit 22 determines presence of a loop path based on a result of comparison between the number of times of reception of the TestData frame per unit time and the threshold. Besides, it is also possible to perform determination by comparing the numbers of times of reception of the TestData frames at the respective communication ports. That is, when there is a large variation in the numbers of times of reception of the TestData frames, it is possible to determine that the communication port with the large number of times of reception is caused by generation of a loop path. For example, in a case where there are communication ports #1 to #3 and when the number of times of reception of the TestData frame at the communication port #2 is larger than those at the communication ports #1 and #3, it may be possible to determine that a loop path is generated and to close the communication port #2.

In the above example, the generation of the loop path is determined by utilizing the TestData frame. Besides, when there is a similar control frame (such a frame as is periodically broadcasted from the communication terminal 10X being the master), such the frame may be utilized to determine the generation of the loop path.

In the above example, the case where the communication network is the CC-Link IE network has been described. Besides, the relay device 20 can be applied to a communication network including a communication terminal that periodically broadcasts a control frame. That is, the loop detection unit 22 of the relay device 20 can detect a loop path by monitoring a reception state (the number of times of reception) of a broadcasted control frame.

As described above, the layer 2 switch 20 according to the present embodiment determines presence or non-presence of a loop path, based on the number of times of reception of a control frame per unit time, the control frame being periodically broadcasted from a master communication terminal in a communication network. When a loop path is detected, the layer 2 switch 20 closes a communication port at which the loop path is detected. Accordingly, it is possible in the CC-Link IE network to easily detect a loop path and to autonomously resolve the loop path.

### Second Embodiment

Next, a relay device (layer 2 switch) according to the second embodiment will be described. It is assumed that a configuration of the layer 2 switch is similar to that in the first embodiment (see FIG. 2).

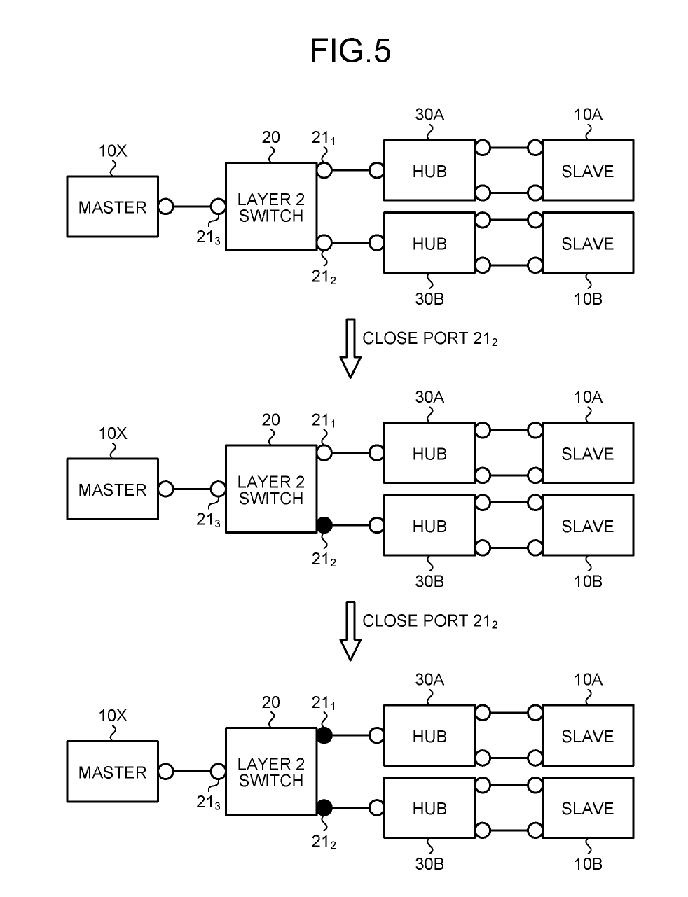

In the above-described first embodiment, the operation of the layer 2 switch 20 in the case where a single communication port satisfies a loop detection condition (i.e. the number of times of reception of TestData frame per unit time>threshold) has been described. In the present embodiment, an operation of the layer 2 switch 20 in a case where there is a plurality of communication ports satisfying the loop detection condition. It should be noted that two cases can be considered as a configuration where there is a plurality of communication ports satisfying the loop detection condition: that is, a case shown in FIG. 4 where a loop path is formed between communication ports of the layer 2 switch 20; and a case shown in FIG. 5 where plural loop paths exist down the layer 2 switch 20.

A communication network shown in FIG. 4 has a configuration where a communication terminal 10X being a master is connected to the communication port 21₃ of the layer 2 switch 20, and a communication terminal 10A being a slave is connected to the communication ports 21₁ and 21₂. In the configuration shown in FIG. 4, a loop path is formed between the communication ports 21₁ and 21₂ of the layer 2 switch 20 and the communication terminal 10A.

On the other hand, a communication network shown in FIG. 5 has a configuration where a communication terminal 10X being a master is connected to the communication port 21₃ of the layer 2 switch 20, a hub 30A is connected to the communication port 21₁, and a hub 30B is connected to the communication port 21₂. Moreover, a communication terminal 10A being a slave is connected to the hub 30A, and a communication terminal 10B being a slave is connected to the hub 30B. In the configuration shown in FIG. 5, a loop path is formed between the hub 30A and the communication terminal 10A and another loop path is formed between the hub 30B and the communication terminal 10B.

When a plurality of communication ports 21 satisfies the loop detection condition, the layer 2 switch 20 cannot determine which one of the cases shown in FIGS. 4 and 5 is caused as the loop shape. Therefore, when a plurality of communication ports 21 satisfies the loop detection condition, the layer 2 switch 20 closes all but arbitrarily-selected one of the communication ports 21 satisfying the loop detection condition.

In the case of the communication network shown in FIG. 4, after a while from the start of operation, the loop detection unit 22 of the layer 2 switch 20 detects that the communication ports 21₁ and 21₂ satisfy the loop detection condition and then closes any one of the communication ports 21₁ and 21₂. For example, the communication port 21₂ is closed. As a result, the loop path between the communication ports 21₁ and 21₂ of the layer 2 switch 20 is resolved. Accordingly, the number of times of reception of TestData per unit time at the communication port 21₁ not closed becomes a normal value equal to or less than the threshold, and thus a loop path is not detected again. Moreover, it is possible to keep the connection between the master (communication terminal 10X) and the slave (communication terminal 10A), because the loop path can be resolved by closing only one point on the loop path.

On the other hand, in the case of the communication network shown in FIG. 5, there are plural loop paths down the layer 2 switch 20. Therefore, even after the loop detection unit 22 of the layer 2 switch 20 closes the communication port 21₂ by a procedure similar to that in the case of the communication network shown in FIG. 4, the loop path down the communication port 21₁ is not resolved and thus the number of times of reception of the TestData per unit time at the communication port 21₁ continues to exceed the threshold. Therefore, if the state where the number of times of reception of the TestData per unit time exceeds the threshold is not resolved, the loop detection unit 22 further closes the communication port 21₁ after an elapse of a certain period of time. As a result, the loop path is resolved.

As described above, in the case where the loop path is detected at a plurality of communication ports 21, the loop detection unit 22 of the layer 2 switch 20 first closes all but arbitrarily-selected one of the communication ports 21 at which the loop path is detected. Then, if the state where the loop path is detected is not resolved, the loop detection unit 22 further closes the one communication port that has not been closed. Accordingly, it is possible to autonomously resolve the loop path while preventing the communication ports from being closed more than necessary.

Besides, when detecting a loop path at a plurality of communication ports 21, the loop detection unit 22 may close the communication ports one by one in order, instead of concurrently closing all but a selected one of the communication ports. That is, the loop detection unit 22 may first close one of the plurality of communication ports at which the loop path is detected, and then monitors a state of the remaining communication port (communication port not closed among the communication ports at which the loop path is detected) for a certain period of time. If the loop path is not resolved, the loop detection unit 22 further closes another one communication port and then monitors the state (monitors for a certain period of time whether or not the loop path is resolved). The loop detection unit 22 repeats the above-mentioned operation until the loop path is completely resolved. By closing one by one the plurality of communication ports at which the loop path is detected, it is possible to certainly prevent the communication ports from being closed more than necessary.

### Third Embodiment

In the foregoing first and second embodiments, a procedure in which the layer 2 switch 20 detects a loop path and resolves the loop path autonomously has been described. It is also possible that the layer 2 switch 20 not only detects the loop path but also notifies a network administrator of the detection of the loop path.

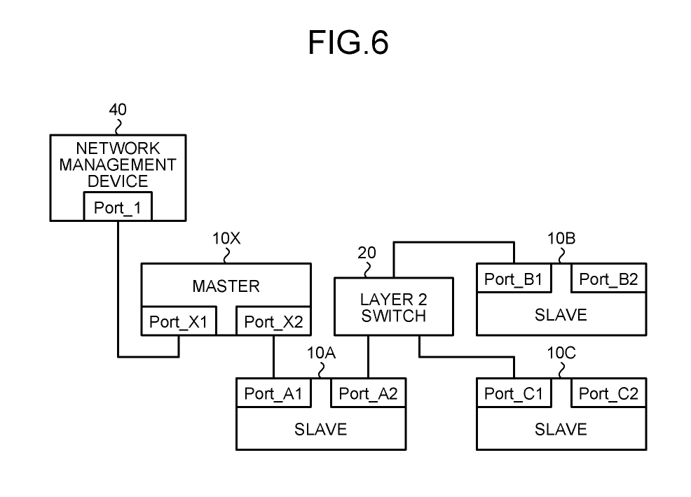

FIG. 6 is a diagram illustrating an example of a configuration of a communication network including a network management device that manages alarm information on the CC-Link IE network. The communication network illustrated in FIG. 6 includes a communication terminal 10X that operates as a master, a plurality of communication terminals 10A to 10C that operate as slaves, a layer 2 switch 20 that is a relay device, and a network management device 40. In the communication network exemplified in FIG. 6, a first communication port (Port_X1) of the communication terminal 10X and a communication port (Port_1) of the network management device 40 are connected to each other, and a second communication port (Port_X2) of the communication terminal 10X and a first communication port (Port_A1) of the communication terminal 10A are connected to each other. A second communication port (Port_A2) of the communication terminal 10A is connected to the layer 2 switch 20. A first communication port (Port_B1) of the communication terminal 10B is connected to the layer 2 switch 20, and a first communication port (Port_C1) of the communication terminal 10C is connected to the layer 2 switch 20. The configuration of the layer 2 switch 20 is similar to that in the first and second embodiments (see FIG. 2).

In the case of the layer 2 switch 20 shown in FIG. 6, when detecting a loop path, the loop detection unit 22 closes a communication port 21 by a procedure similar to that in the first and second embodiments, and further generates a loop detection notification frame destined to the network management device 40 to transmit it through the frame relay unit 23 and the communication port 21. When receiving the loop detection notification frame, the network management device 40 notifies a network administrator of the detection of the loop path, for example by displaying it on a display unit (not shown).

According to the communication network of the present embodiment, it is possible not only to autonomously resolve a loop path but also to quickly notify the network administrator (network management terminal 40) of the detection of the loop path.

In each of the embodiments, a case where there is one layer 2 switch belonging to a communication network has been described. The same applies to each layer 2 switch in a case where there are two or more layer 2 switches belonging to the network.

### Industrial Applicability

As described above, the relay device and the communication network according to the present invention are useful for achieving an Ethernet-based FA network.

### REFERENCE SIGNS LIST

10X communication terminal (master), 10A, 10B, 10C, 10D communication terminal (slave), 20 layer 2 switch, 21₁, 21₂, 21₃, 21ₙ communication port, 22 loop detection unit, 23 frame relay unit, 30, 30A, 30B hub, 40 network management device.

1. A relay device belonging to a communication network, the relay device comprising:
a plurality of communication ports to transmit and receive frames; and
a reception frequency monitor
to monitor a frequency of reception of a control frame with respect to each of the communication ports, the control frame being periodically transmitted into the communication network from a communication device belonging to the communication network, and
to instruct a communication port at which the frequency of reception exceeds a threshold to stop a frame transmission and reception operation,
wherein when there is a plurality of communication ports at which the frequency of reception exceeds the threshold, the reception frequency monitoring unit instructs all but one of the plurality of communication ports at which the frequency of reception exceeds the threshold to stop the frame transmission and reception operation.

2. The relay device according to claim 1, wherein the control frame is a control frame transmitted to check a state of the communication network.

3. (canceled)

4. The relay device according to claim 1, wherein when there is still a communication port at which the frequency of reception exceeds the threshold even after a certain period of time since the reception frequency monitor instructs all but one of the plurality of communication ports at which the frequency of reception exceeds the threshold to stop the frame transmission and reception operation, the reception frequency monitor instructs the communication port at which the frequency of reception exceeds the threshold to stop the frame transmission and reception operation.

5. The relay device according to claim 1, wherein when detecting the communication port at which the frequency of reception exceeds the threshold, the reception frequency monitoring unit monitor transmits information indicating the detection to a management device of the communication network.

6. The relay device according to claim 1, wherein the communication network is a communication network that connects between FA (Factory Automation) devices.

7. The relay device according to claim 1, wherein the communication network is a CC-Link IE network.

8. A communication network comprising the relay device according to claim 1.
